(19) United States
(12) Patent Application Publication
(10) Pub. No.: US 2017/0093026 A1
(43) Pub. Date: Mar. 30, 2017

(54) FIN-TYPE ANTENNA ASSEMBLIES

(71) Applicant: TAOGLAS GROUP HOLDINGS, Enniscorthy (IE)

(72) Inventors: Christopher M. ANDERSON, Minneapolis, MN (US); Dermot O'SHEA, La Jolla, CA (US); Ronan QUINLAN, Dublin (IE)

(73) Assignee: TAOGLAS GROUP HOLDINGS, Enniscorthy (IE)

(21) Appl. No.: 15/271,421

(22) Filed: Sep. 21, 2016

Related U.S. Application Data
(60) Provisional application No. 62/232,786, filed on Sep. 25, 2015.

(51) Int. Cl. H01Q 1/32; H01Q 21/00; H01Q 1/22

(52) U.S. Cl. CPC H01Q 1/3275; H01Q 1/2291; H01Q 21/00

(57) ABSTRACT

Communication assemblies are disclosed which comprises, a chassis, ground plane and one or more antenna subassemblies. Antenna assemblies include LTE, WI-FI, AM/FM, GPS and SDARS antennas. Some or all antenna subassemblies may consist of a multi-antenna configuration with each antenna appearing visually as a blade. For subassemblies configured in a multi-antenna arrangement, blades are configurable at a spacing optimal to implement MIMO or path diversity for instance for WIFI or LTE communications schemes. A chassis mechanism can be provided which holds elements of the antenna subassemblies in place and also acts as a ground plane. One or more feed lines which lead from each antenna subassembly and out of the molded enclosure can also be provided. A housing is provided which follows the general contours of the antenna subassemblies and is comprised of a material transparent to the frequencies utilized by the antenna subassemblies. The housing can be shaped in an aerodynamic morphology.

### CROSS-REFERENCE

This application claims the benefit of U.S. Provisional Application No. 62/232,786, filed Sep. 25, 2015, entitled FIN-TYPE ANTENNA ASSEMBLIES which application is incorporated herein by reference.

### BACKGROUND

Field of the Disclosure

The present disclosure relates to communication assemblies and more particularly to a fin-type communications system comprising multiple communications systems including multi-antenna communications protocols suitable for use on a vehicle.

Description of Related Art

New antenna and receiver diversity and Multiple In Multiple Out (MIMO) radio applications require more than one antenna on the same frequency within a small device volume. In a typical application this was addressed by having multiple separate antennas, each with a separate enclosure or sometimes multiple antenna elements housed in a single radome. Multiple, separately enclosed antennas cost more to implement than a single enclosure with multiple internal antenna elements. A single enclosure without provisions for separating the antenna elements leads to poor antenna performance and a bulky casing appearance. What is needed is an antennae assembly that provides a single housing enclosure that contains a plurality of antenna elements wherein each antenna element is positioned within the housing such that each antenna element achieves optimal performance.

### SUMMARY

Communication assemblies are disclosed which comprise, a chassis, a ground plane structure, and one or more antenna subassemblies positioned within a housing. Subassemblies can include, for example, wire, patch, microstrip, travelling wave or other types of communications antenna. Some or all antenna subassemblies may include a multi-antenna configuration appearing visually as a blade or other suitable planar structure. For subassemblies configured in a multi-antenna arrangement, blades are configured at a spacing optimal to implement MIMO or path diversity for instance for WI-FI® or LTE communications schemes.

A molded enclosure or housing is configurable to encompass and follow the general contours of the antenna subassemblies positioned within the housing. The housing is formed from a material that is transparent to the frequencies utilized by the antenna subassemblies. The housing can be shaped in an aerodynamic morphology.

The communication assembly may be utilized in a variety of applications including, but not limited to vehicular, underwater, air or space flight. In the vehicular application, the communication assembly may be attached to the roof of a car or truck. To minimize drag in the direction of travel, the housing will typically take the form of a finned or multi-finned device, wherein each blade contained within the housing corresponds to a protruding fin structure of the housing. The communication assembly may optionally be affixed to provide a multitude of modern communications schemes in a small compact device.

An aspect of the disclosure is directed to a communications assembly. Suitable communications assemblies comprise: a housing having a length and a width and a base and a cover wherein the base and the cover have an exterior surface and an interior cavity when mated and wherein the housing has a first end and a second end and has a cross-section in the shape of an inverted W across at least a portion of a cross-section along a portion of the length; a chassis positionable on an interior facing surface of the base; two or more antenna subassemblies positioned within the cavity of the housing in communication with the chassis wherein at least two antenna subassemblies are perpendicular to a chassis plane. In some configurations, the assembly is configured to implement multi-antenna protocols. Additionally, the multiple-antenna protocols are selected from the group comprising LTE, WI-FI, AM/FM, GPS (global positioning system) and SDARS (satellite digital audio radio service). Moreover, the communications assembly is connectable to an external line feed and a fixed point located exterior to the housing in at least some configurations. The communications assembly is also configurable to connect to a vehicle in some configurations. The cross-sectional shape can be an inverted W, or have a plurality of fins, from two to sixteen. The housing first end can be tapered and the housing second end wider than the first end.

Another aspect of the disclosure is directed to an antenna comprising a housing formed from a base and a cover having a tapered first end and a widened second end wherein the housing encloses a chassis disposed and a plurality of antenna units, wherein the antenna further comprises: a first antenna unit disposed perpendicular to the chassis on a first side of the chassis positioned toward the widened second end of the housing; a second antenna unit disposed perpendicular to the chassis on a second side of the chassis positioned toward the widened second end of the housing; a third antenna unit disposed perpendicular to the chassis on the first side of the chassis and positioned toward the tapered end of the housing; a fourth antenna unit disposed perpendicular to the chassis on the second side of the chassis and positioned toward the tapered end of the housing; a fifth antenna unit disposed parallel to the chassis and positioned toward the tapered end of the housing, wherein the first antenna, second antenna, third antenna, fourth antenna and fifth antenna are selected from the group comprising: LTE antenna, WI-FI antenna, AM/FM antenna, GPS antenna and SDARS antenna. Additionally, the antenna is configurable to implement multi-antenna protocols. In at least some configurations, the antenna is connected to an external line feed and a fixed point located exterior to the housing. In some implementations the antenna is configurable to connect to a vehicle. Additionally, the exterior housing can form two fins in the shape of an inverted W in a cross-section along a portion of the cover, or an inverted V or U in a cross-section along a portion of the cover. The cross-sectional shape can be an inverted W, or have a plurality of fins, from two to sixteen.

Still another aspect of the disclosure is directed to an antenna comprising a housing means formed from a base and a cover having a tapered first end and a widened second end wherein the housing means encloses a chassis means disposed and a plurality of antenna unit means, wherein the antenna further comprises: a first antenna means disposed perpendicular to the chassis means on a first side of the chassis means positioned toward the widened second end of the housing means; a second antenna means disposed perpendicular to the chassis means on a second side of the chassis means positioned toward the widened second end of the housing; a third antenna means disposed perpendicular to the chassis means on the first side of the chassis means and positioned toward the tapered end of the housing means; a fourth antenna means disposed perpendicular to the chassis means on the second side of the chassis means and positioned toward the tapered end of the housing means; a fifth antenna means disposed parallel to the chassis means and positioned toward the tapered end of the housing means; wherein the first antenna means, second antenna means, third antenna means, fourth antenna means and fifth antenna means are selected from the group comprising: LTE antenna, WI-FI antenna, AM/FM antenna, GPS antenna and SDARS antenna. Additionally, the antenna means is configurable to implement multi-antenna protocols. In some configurations, the antenna means is connected to an external line feed and a fixed point located exterior to the housing means. Additionally, in some configurations, the antenna means is configurable to be connected to a vehicle. The exterior housing means is configurable to form two fins in the shape of an inverted W in a cross-section along a portion of the cover in some configurations. Alternatively, the exterior housing means forms a single fin in the shape of an inverted V or U in a cross-section along a portion of the cover in other configurations.

Yet another aspect of the disclosure is directed to a communications assembly means comprising: a housing means having a length and a width and a base and a cover wherein the base and the cover have an exterior surface and an interior cavity when mated and wherein the housing means has a tapered first end and a widened second end and has a cross-section in the shape of an inverted W at a cross-section along a portion of the length at the second end; a chassis means positionable on an interior facing surface of the base; two or more antenna subassemblies means positioned within the cavity of the housing means in communication with the chassis means wherein at least two or more antenna subassemblies means are positioned within the cavity of the housing means in communication with the chassis means wherein at least two antenna subassemblies are perpendicular to a chassis plane. In some configurations, the communications assembly is configurable to implement multi-antenna protocols. Additionally, the multiple-antenna protocols of the communications assembly means are selectable from the group comprising LTE and WI-FI. In some configurations, the communications assembly means is connectable to an external line feed and a fixed point located exterior to the housing means. The communications assembly means can also be configured to be connected to a vehicle.

Another aspect of the disclosure is directed to communication assemblies comprising: a housing having a length and a width and a base and a cover wherein the base and the cover have an exterior surface and an interior cavity when mated and wherein the base of the housing has a tapered first end and a widened second end and has a cross-sectional shape at a cross-section along a portion of the length at the second end; a chassis positionable on an interior facing surface of the base; and two or more antenna subassemblies positioned within the cavity of the housing in communication with the chassis wherein at least two antenna subassemblies are perpendicular to a chassis plane, wherein the cross-sectional shape at the cross-section along the portion of the length of the second end is a shape that outlines a profile of the two or more antenna subassemblies positioned within the cavity of the housing at the second end of the housing. In some configurations, the assembly is configured to implement multi-antenna protocols. Additionally, the multiple-antenna protocols are selected from the group comprising LTE and WI-FI. Moreover, the communications assembly is connectable to an external line feed and a fixed point located exterior to the housing in at least some configurations. The communications assembly is also configurable to connect to a vehicle in some configurations. Additionally, the cross-sectional shape of the housing can be from 10%-50% larger than the profile of the two or more antenna subassemblies positioned within the cavity of the housing.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example. U.S. Pat. No. 8,836,604 B2 issued Sep. 16, 2014, to Yang et al. for Unified Antenna of Shark Fin Type; U.S. Pat. No. 7,408,511 B2 issued Aug. 5, 2008, to Liu for MIMO Antenna Configuration; US 2013/0274519 A1 published Nov. 1, 2012, to Chikam et al. for Highly Integrated Multiband Shark Fin Antenna for Vehicle; U.S. Pat. No. 8,947,307 B2 issued Feb. 3, 2015, to Lo for Shark Fin Type Car Antenna Assembly; US 2008/0218412 A1 published Sep. 11, 2008 to Wales for Quad Polar Transmission; U.S. Pat. No. 7,239,281 B2 issued Jul. 3, 2007 to Lu for Fin-Shaped Antenna Apparatus for Vehicle Radio Application; WO 2014/204494 A1 published Dec. 24, 2014 to Laird Technologies for Multiband MIMO Vehicular Antenna Assemblies; WO 2014/07263 A1 published May 15, 2014, to The University of Birmingham, for Reconfigurable MIMO Antenna for Vehicles; and US 2014/0347231 A1 published Nov. 27, 2014, to Kerselaers et al. for Vehicle Antenna.

### BRIEF DESCRIPTION OF THE DRAWINGS

The novel features of the invention are set forth with particularity in the appended claims A better understanding of the features and advantages of the present invention will be obtained by reference to the following detailed description that sets forth illustrative embodiments, in which the principles of the invention are utilized, and the accompanying drawings of which:

FIG. 1 is a perspective view of the housing with the cover removed;

FIGS. 2A-C are rear views of an antenna which includes a view into the back of the antenna housing with the back face of the housing cut away and the components positioned therein, an enlargement of a portion of the back view and an angled view into the interior of the antenna from the rear perspective;

FIGS. 3A-B are exterior views of an antenna housing according to the disclosure;

FIGS. 4A-B illustrate an antenna housing according to the disclosure with four fins; and

FIGS. 5A-B illustrate an antenna housing according to the disclosure with sixteen fins.

### DETAILED DESCRIPTION

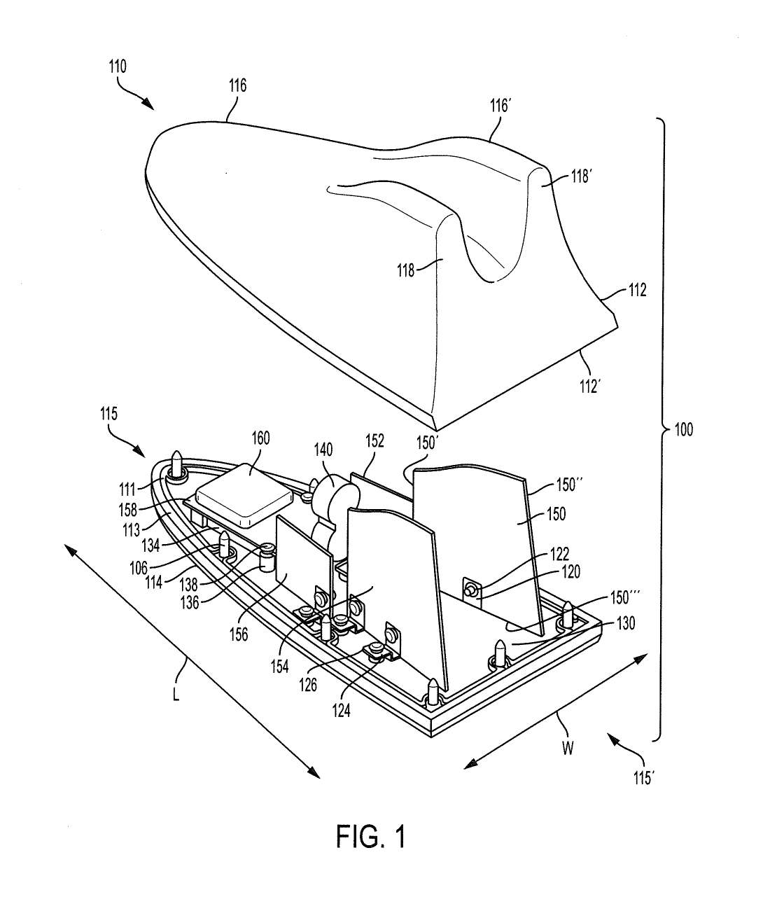

Referring to the drawings and initially to FIG. 1 a fin antenna assembly 100 in accordance with an embodiment of the disclosure is provided. The fin antenna assembly 100 comprises a housing 110 having a cover 112 and a base 114 with a length L, width W, and height H. The housing 110 is configured to enclose a plurality of components including a chassis 130, which can provide a mechanical feature on which to mount other antenna elements as needed and which can also provide a ground plane structure for those additional antennas, and a plurality of antenna elements 140, 150, 152, 154, 156, 160 including two Long Term Evolution (LTE) antennas, two Wi-Fi antennas, a patch antenna and an AM/FM antenna element. The LTE antennas can operate between 400 MHz and 6 GHz. The housing shape can be at least in part determined by the placement of the antenna elements and a PCB 158 within the housing.

The base 114 of the housing 110, as illustrated, is substantially planar in a first dimension and configurable so that it has a tapered shape at a first end 115 and has a width W that is increased gradually from the first end 115 of the base 114 toward the second, opposing, end 115′ of the base 114. The base 114 has a lip 113 forming an exterior surface of the base 114 which extends perpendicular to the substantially planar base. An interior surface 111 of the base 114 securely receives the chassis 130 and a plurality of antenna elements. The lip 113 can be integrally formed with the base 114 or be attached to the base 114 during the manufacturing process. In one configuration, the lip 113 can be formed so that it fits within a channel formed in a lower surface of the cover 112. Alternatively, the lip 113 can be configured to provide a snug fit either internally or externally to the cover 112.

The chassis 130 is positionable on an interior facing surface of the base 114. The chassis 130 can be secured to the base 114 by any suitable fastening process including, for example, the use of a plurality of retaining fasteners. Alternatively, the chassis can be secured using a snap system. One or more posts 106 can be provided which extend from interior surface of the base 114 and engage corresponding female molded apertures in the cover 112 to provide a mechanism for aligning and securing the cover 112 to the base 114. The one or more posts 106 can pass through cutouts in the chassis 130, as illustrated, or can pass adjacent to a chassis 130 that is sized to fit within the base without engaging the edges formed by the lip 113 of the base. Additionally, one or more stems 136 can extend from the chassis 130 and provide an aperture through which a securement device 138 is passed.

Antenna elements 140, 150, 152, 154, 156, 160 are examples of a plurality of similar antenna elements which are mountable to the chassis 130 within the housing. Mounting can be achieved via an antenna mounting and line feed mechanism which includes, for example, a plurality of flanges 120 extending perpendicularly with a corresponding fastener 122 passing through the flange 120 and an associated antenna, such as antenna element 150. The flange 120 and fastener 122 arrangement secures the antenna element in a position perpendicular, or substantially perpendicular to the chassis 130. Additionally, a second flange 124 which has a face parallel to the chassis 130 and perpendicular to the antenna element 154 can be provided which is secure via fastener 126 which engages the base 114. Other mounting mechanisms can be used without departing from the scope of the disclosure. Flange 120 and second flange 124 may also be integrally formed.

As illustrated the antenna element 150 is mounted vertically to a horizontally positioned base 114 and aligned such that a front edge 150′ of the antenna element 150 is positioned nearest the first end 115 of the base 114, while the back end 150″ of the antenna element 150 is positioned nearest second end 115′ of the base 114, the lower edge 150′″ of the antenna element 150 is adjacent the chassis 130, where the chassis 130 is configurable to function as a ground plane. A vertical array element, such as described, can also be referred to as a blade.

Blades are used for antenna elements in the back left 150, back right 154, mid left 156 and mid right, 152. Blades comprise a non-conducting substrate and a radiating element specially shaped to transmit and receive for a given communications protocol. Blades are positioned to maximize reception of the communications protocol.

Parallel antenna element 154 (back blade, left) and antenna element 150 (back blade, right), together with their respective antenna mounting and flanges 120, 124 comprise a multi-antenna subassembly which is configured with radiating elements of determined shape and blade separation to implement the receipt and transmission of 4G Long Term Evolution (LTE), for either MIMO or signal path diversity.

Similarly, parallel antenna element 156 (mid blade, left) and antenna element 152 (mid blade, right), together with respective antenna mounting and flanges or line feed elements, comprise a multi-antenna subassembly which is configured with radiating elements of determined shape and blade separation to implement the receipt and transmission of WI-FI for the Multiple Input Multiple Output (MIMO) or signal path diversity and WI-FI. Separation of antenna element 150 (back blade, right) and antenna element 154 (back blade, left) enhance the performance of received and transmitted signals. The chassis 130 is a ground plane. Coax cables are provided to route signals from an element to the radio.

A patch antenna 160 is mounted to the chassis 130 via a suitable antenna mounting and flanges 120. The patch antenna 160 is positioned parallel to the surface of the chassis, such that it consists of a non-conducting substrate and radiating elements of determined shape. The radiating elements similarly utilize the secondary function of the chassis 130 in functioning as a ground plane. As illustrated, the patch antenna 160 can be positioned on a PCB 158 which acts as a ground plane for the element. The opposite side of the PCB 158 is positioned on a pedestal 134 on the chassis 130 and includes additional electronic components including a filter and a low noise amplifier (LNA).

The cover 112 is mounted on the base 114 to cover the chassis 130 and associated components. The cover 112 is shaped such that the bottom edge 112′ engages the lip 113 of the base 114. The upper surface of the cover 112 has a rounded first end 116 corresponding to the first end 115 of the base 114 and a fin shaped second end 116′ corresponding to the second end 115′ of the base 114. Thus, the antenna assembly 100 of FIG. 1 has the shape of one or more fins. As shown in FIG. 1, the antenna assembly has a first fin 118 and second fin 118′. In such a manner, the vehicle antenna assembly of FIG. 1 reduces the air drag of the vehicle during movement.

In addition, the antenna assembly 100 is protected by the housing 110 and will not be deformed or broken due to physical damage or weather, thereby enhancing the lifetime of the car antenna assembly 100.

Positioning of the antenna elements within the housing provides for at least 10 dB of isolation between the antenna elements.

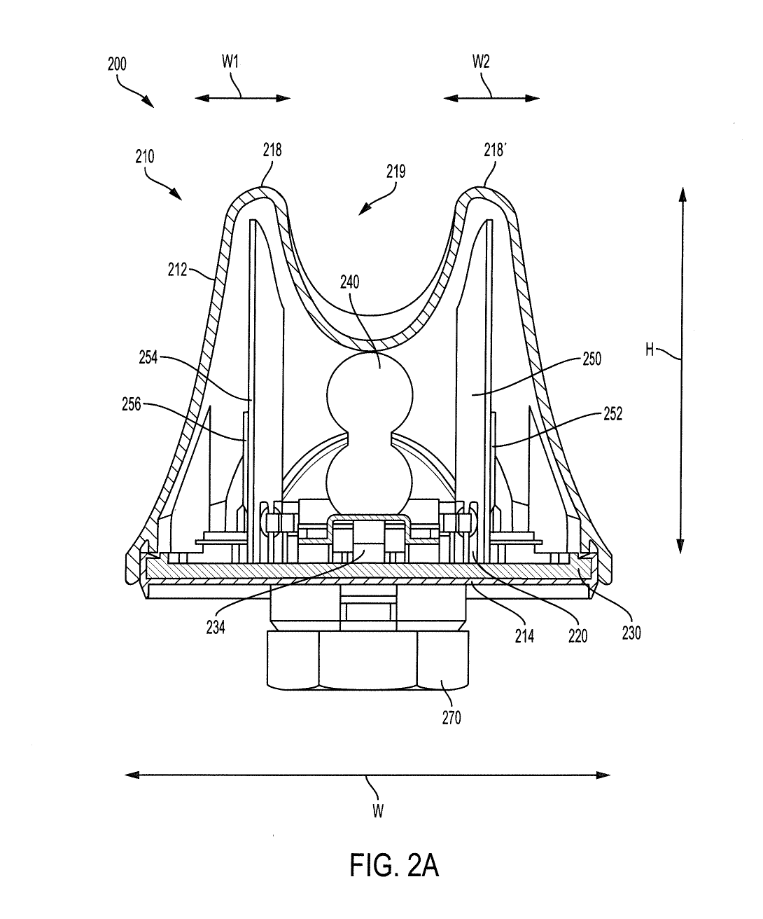

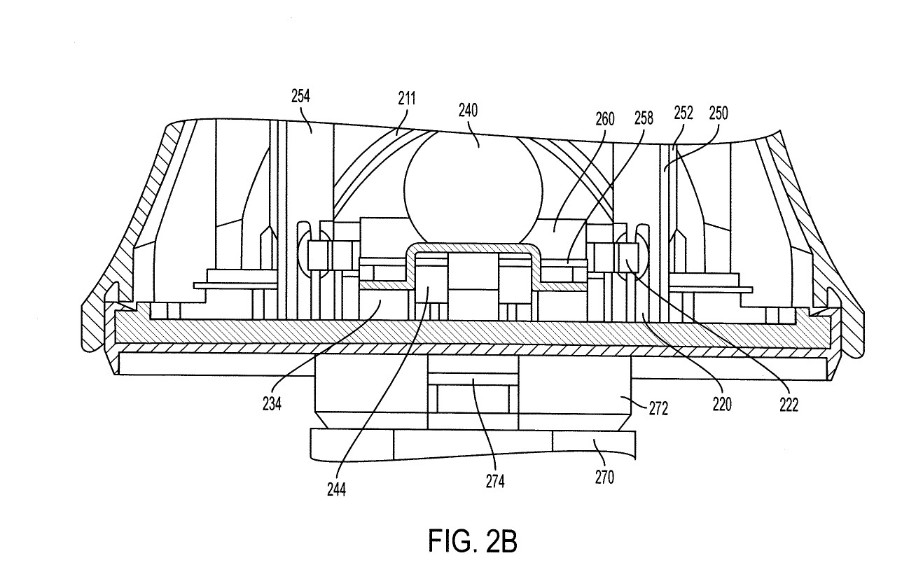

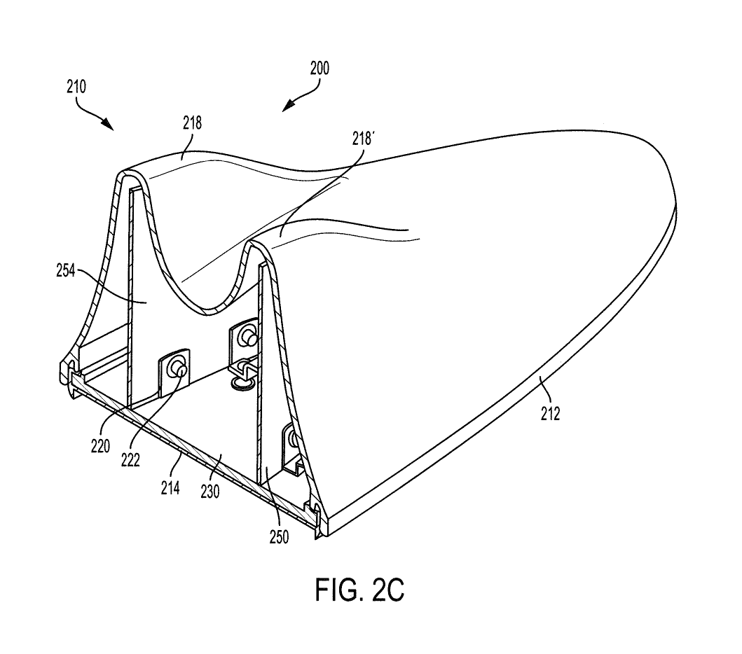

Referring to FIGS. 2A-C a multi-fin-type antenna is shown from the rear perspective looking forward to the first end 115 of the device shown in FIG. 1. The first fin 218, is shown contoured around the LTE blade 254, and second fin 218′ contours around LTE blade 250. Between the two peaks of the first fin 218 and the second fin 218′, the top cover 212 of the housing 210 defines an aperture which houses the components of the antenna assembly. The upper surface of the housing curves down to a middle trough 219. First LTE blade 250 and second LTE blade 254 are shown connected physically and electrically to the chassis 230 via antenna mounting and flange 220 which can be a line feed element. Some components can be positioned on a pedestal 234.

Situated parallel to LTE blade 250 and LTE blade 254 and the WI-FI blade 252 and LTE blade 256 which are shown connected physically and electrically to the chassis 230 which acts as a ground plane via antenna mounting and flange 220. A fastener 222 can pass through the flange 220. A pedestal 234 can be provided which can support at least a portion of an RF shield 244.

A cable holder can be provided to house cables within the interior of the antenna assembly 200. A metal base 230 can be provided which is positionable within the housing 210. The top cover 212 can be formed with a rib 211 on an interior surface which provides mechanical strength to the top cover 212. Patch antenna 260 can also be provided. The patch antenna 260 can be positioned on an PCB 258. The antenna securement mechanism 270 can also include a spacer washer 272 and a water seal plug 274. The water seal plug helps to ensure that the interior of the antenna is resistant to moisture.

The top cover 212 of the housing 210 is shown locking into the base 214 via locking elements on both sides, shown in more detail in FIG. 1. Each fin of the top cover can have a width W1 and W2. The width of each fin can be the same, substantially the same, or different. Antenna securement mechanism 270, such as a hex head nut which engages a threaded bolt or protrusion extending from the bottom exterior surface of the base 214, is provided which secures the antenna assembly 200 to another device, such as a vehicle.

Ground plane 230 is positioned at point, such as the midpoint, between the two multi-antenna arrays. The top of the ground plane 230 can be configured so that it touches an interior surface of the housing (as shown).

As will be appreciated by those skilled in the art, the cover of the enclosure is configured so that it wraps around the antenna elements. Thus at least portions of the exterior shape may be a function of the position and orientation of the components within the housing. For example, the shape of the housing can have a cross-sectional shape along a portion of its length that is an inverted V, an inverted U, an inverted W, or any other shape that is conforming to the shape of the interior components. If, for example, the maximum height from the base to the top of the highest component within the disclosure is 10 cm, then the height of the enclosure could be from 11 cm to 15 cm (e.g., from 10% to 50% larger). Additionally, the housing can be from 10%-50% larger than the dimension of the profile of the components to be housed along any portion of its length. Where there are two blades, as shown in FIG. 1, the depth of the valley between two fins could be shallow or deep depending upon how high the components positioned within the blades are. For example, as can be seen in FIG. 1, the height of the AM/FM antenna 140 which is positioned between the antenna elements 152, 156 (right and left mid blades) influences the depth of the valley between the two blades. Where, for example, the AM/FM antenna 140 had a greater height, the cross-section may take on a squarer cross-sectional shape.

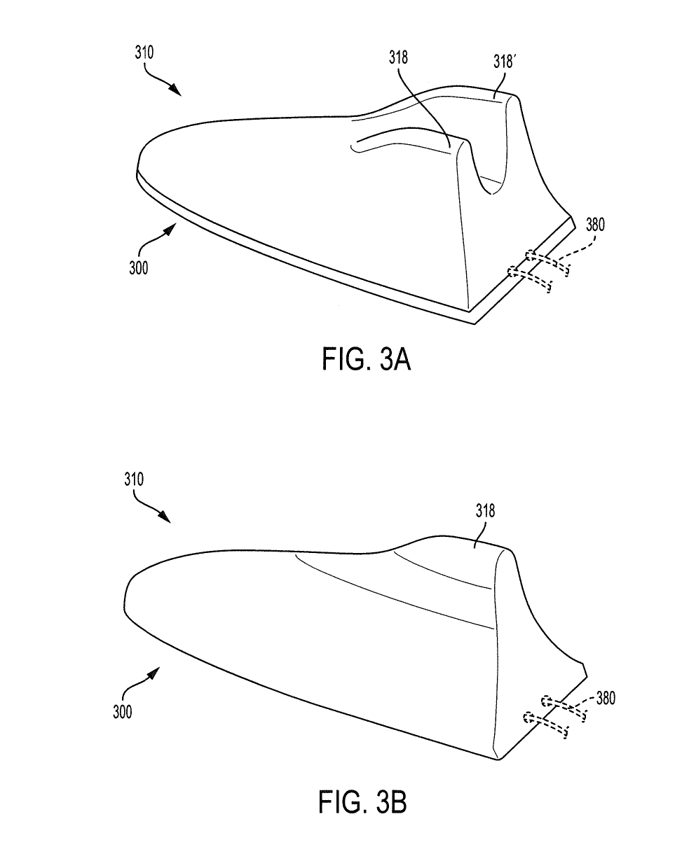

FIGS. 3A and B depict an exterior view of the devices having one or more fins. As illustrated the housing 310 in FIG. 3A has a cross-sectional shape of an inverted W along a length towards the second end, and a cross-sectional shape of an V or U along a length towards the second end as shown in FIG. 3B.

As will be appreciated by those skilled in the art, the housing protects the interior elements of the device from damage due to dust, rain or other physical or elemental factors. Additionally, the upper portion of the housing (the cover) can be formed from a single shaped piece of plastic, or any other suitable material. Suitable materials include, but are not limited to, acrylonitrile-butadiene-styrene (ABS), fiberglass and polycarbonate. The exterior shape of the housing can be a standard ‘shark fin’ antenna radome design, or a dual two fins antenna radome having a first fin 318 and a second fin 318′. The actual external shape can vary based on, among other things, the design choice and layout of the internal components.

Communications cables or connections can also be provided protrude from the housing at an optimal position to provide the signals to and from the plurality of antenna subassemblies which function within the housing. For illustration purposes only, FIG. 3B shows wires 380 extending from the back end of the housing 310 of the antenna assembly 300. However, in most configurations the wires would extend from the bottom surface through the base. The communication connections can also be incorporated into the antenna securement mechanism 270 (shown in FIG. 2).

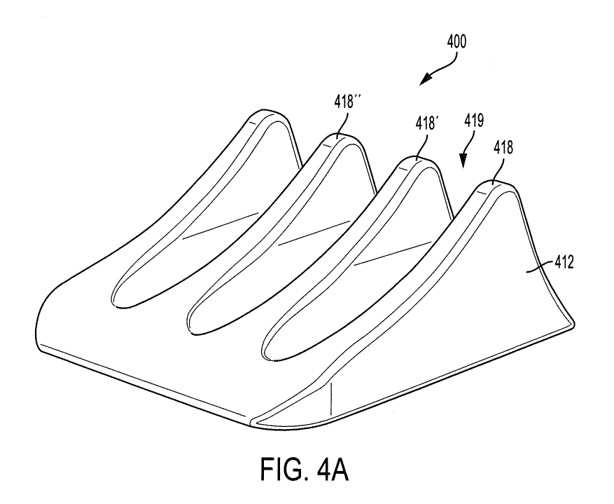

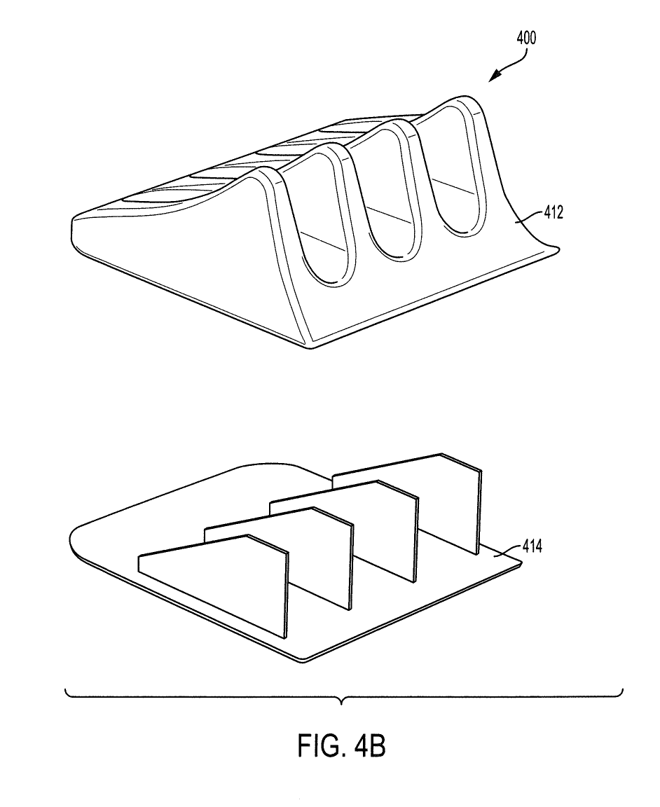

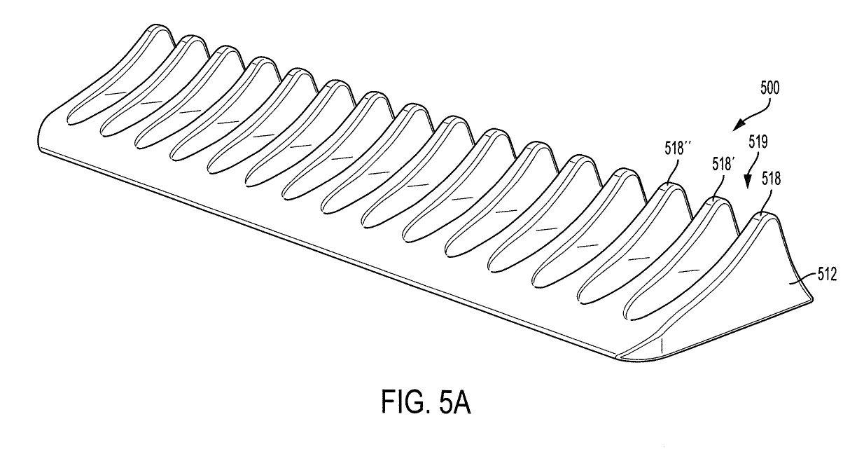

FIGS. 4A-B illustrates fin antenna assembly 400. The fin antenna assembly 400, has a plurality of fins 418, 418′, 418″ which is shown as four fins in FIGS. 4A-B. Each pair of fins has a trough 419 positioned between adjacent fins. The base 414 can have a plurality of vertical members positioned along its length which extend into an interior hollow cavity of each of the plurality of fins. The number of vertical members can be the same as the number of fins provided, as illustrated in FIGS. 4A-B. The number of fins provided can correspond to a number of coaxial cables connecting to the antenna assembly.

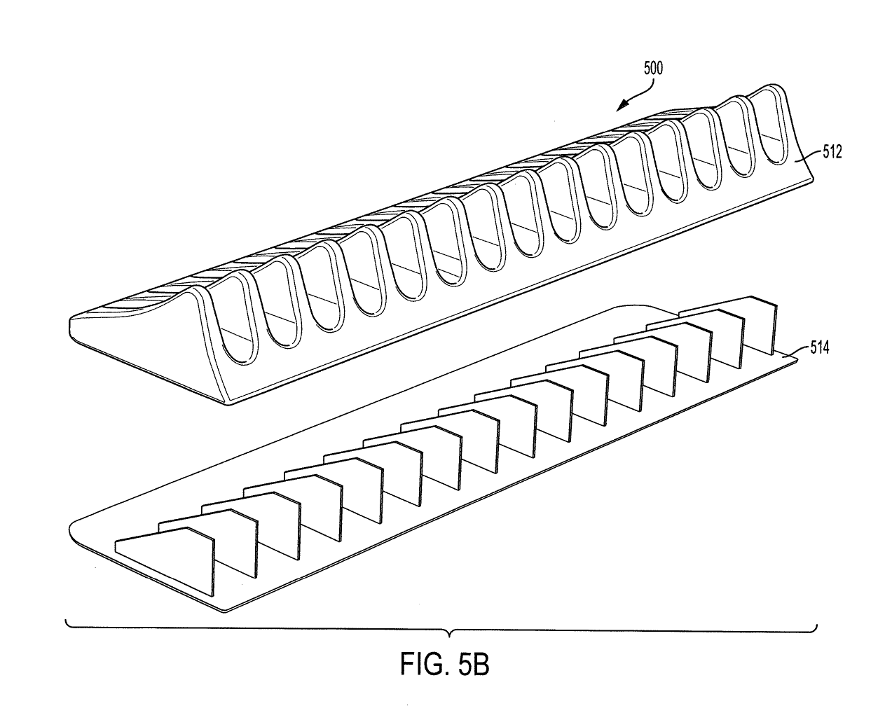

FIGS. 5A-B illustrates fin antenna assembly 500. The fin antenna assembly 500, has a plurality of fins 518, 518′, 518″ which is shown as sixteen fins in FIGS. 5A-B. Each pair of fins has a trough 519 positioned between adjacent fins. The base 514 can have a plurality of vertical members positioned along its length which extend into an interior hollow cavity of each of the plurality of fins. The number of vertical members can be the same as the number of fins provided, as illustrated in FIGS. 5A-B. As will be appreciated by those skilled in the art, the number of vertical members need not correlate to the number of fins provided.

The number of fins provided can correspond to a number of coaxial cables connecting to the antenna assembly. Additionally, positioning of the antenna elements shown in FIGS. 1-3 in the configurations of FIGS. 4-5 can vary depending on the number of antenna elements incorporated, as will be appreciated by those skilled in the art.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A communications assembly comprising:
a housing having a length and a width and a base and a cover wherein the base and the cover have an exterior surface and an interior cavity when mated and wherein the base of the housing has a first end and a second end and has a cross-section in the shape of an inverted W across at least a portion of a cross-section along a portion of the length adjacent the second end;
a chassis positionable on an interior facing surface of the base; and
two or more antenna subassemblies positioned within the cavity of the housing in communication with the chassis wherein at least two antenna subassemblies are perpendicular to a chassis plane.

2. The communications assembly of claim 1 wherein the assembly is configured to implement multi-antenna protocols.

3. The communications assembly of claim 1 wherein the multiple-antenna protocols are selected from the group comprising LTE, WI-FI, AM/FM, GPS and SDARS.

4. The communications assembly of claim 1, wherein the communications assembly is connected to an external line feed and a fixed point located exterior to the housing.

5. The communications assembly of claim 1, wherein the communications assembly is connected to a vehicle.

6. The communication assembly of claim 1, wherein the cross-sectional shape has a plurality of inverted Ws.

7. The communication assembly of claim 6, wherein the plurality of Ws is from 2 to 8.

8. The communication assembly of claim 1, wherein the housing first end is tapered and the housing second end is wider than the first end.

9. The communication assembly of claim 1 wherein the cover slopes from a maximum height towards the front end.

10. An antenna comprising a housing formed from a base and a cover having a first end and a widened second end wherein the housing encloses a chassis disposed and a plurality of antenna units, wherein the antenna further comprises:
a first antenna unit disposed perpendicular to the chassis on a first side of the chassis positioned toward the widened second end of the housing;
a second antenna unit disposed perpendicular to the chassis on a second side of the chassis positioned toward the widened second end of the housing;
a third antenna unit disposed perpendicular to the chassis on the first side of the chassis and positioned toward the tapered end of the housing;
a fourth antenna unit disposed perpendicular to the chassis on the second side of the chassis and positioned toward the tapered end of the housing; and
a fifth antenna unit disposed parallel to the chassis and positioned toward the tapered end of the housing,
wherein the first antenna, second antenna, third antenna, fourth antenna and fifth antenna are selected from the group comprising: LTE antenna, WI-FI antenna, AM/FM antenna, GPS antenna and SDARS antenna.

11. The antenna of claim 10 wherein the antenna is configured to implement multi-antenna protocols.

12. The antenna of claim 10, wherein the antenna is connected to an external line feed and a fixed point located exterior to the housing.

13. The antenna of claim 10, wherein the antenna is connected to a vehicle.

14. The antenna of claim 10, wherein the exterior housing forms two fins in the shape of an inverted Win a cross-section along a portion of the cover.

15. The antenna of claim 10, wherein the exterior housing forms a fin in the shape of an inverted V in a cross-section along a portion of the cover.

16. The antenna of claim 10, wherein the cross-sectional shape has a plurality of inverted Ws.

17. The antenna of claim 16, wherein the plurality of Ws is from 2 to 8.

18. An antenna comprising a housing means formed from a base and a cover having a first end and a widened second end wherein the housing means encloses a chassis means disposed and a plurality of antenna unit means, wherein the antenna further comprises:
a first antenna means disposed perpendicular to the chassis means on a first side of the chassis means positioned toward the widened second end of the housing means;
a second antenna means disposed perpendicular to the chassis means on a second side of the chassis means positioned toward the widened second end of the housing;
a third antenna means disposed perpendicular to the chassis means on the first side of the chassis means and positioned toward the tapered end of the housing means;
a fourth antenna means disposed perpendicular to the chassis means on the second side of the chassis means and positioned toward the tapered end of the housing means; and
a fifth antenna means disposed parallel to the chassis means and positioned toward the tapered end of the housing means,
wherein the first antenna means, second antenna means, third antenna means, fourth antenna means and fifth antenna means are selected from the group comprising: LTE antenna, WI-FI antenna, AM/FM antenna, GPS antenna and SDARS antenna.

19. The antenna means of claim 18 wherein the antenna means is configured to implement multi-antenna protocols.

20. The antenna means of claim 18, wherein the antenna means is connected to an external line feed and a fixed point located exterior to the housing means.

21. The antenna means of claim 18, wherein the antenna means is connected to a vehicle.

22. The antenna means of claim 18, wherein the exterior housing means forms two fins in the shape of an inverted W in a cross-section along a portion of the cover.

23. The antenna means of claim 18, wherein the exterior housing means forms a single fin in the shape of an inverted V in a cross-section along a portion of the cover.

24. The antenna means of claim 18, wherein the cross-sectional shape has a plurality of inverted Ws.

25. The antenna means of claim 24, wherein the plurality of Ws is from 2 to 8.

26. A communications assembly means comprising:
a housing means having a length and a width and a base and a cover wherein the base and the cover have an exterior surface and an interior cavity when mated and wherein the housing means has a first end and a second end and has a cross-section in the shape of an inverted W at a cross-section along a portion of the length at the second end;
a chassis means positionable on an interior facing surface of the base;
three or more antenna subassemblies means positioned within the cavity of the housing means in communication with the chassis means wherein at least one antenna subassembly means is perpendicular to a chassis means plane and one antenna subassembly means is perpendicular to the chassis means plane;
wherein the chassis means is a ground plane for the antenna subassemblies means and at least one of the antenna subassemblies means implements a MIMO having multiple antenna configured at a target spacing, and further wherein a shape of an upper surface of the housing means conforms to an outline of a perpendicularly positioned antenna subassembly means.

27. The communications assembly means of claim 26 wherein the assembly means is configured to implement multi-antenna protocols.

28. The communications assembly means of claim 26 wherein the multiple-antenna protocols are selected from the group comprising LTE, WI-FI, AM/FM, GPS and SDARS.

29. The communications assembly means of claim 26, wherein the communications assembly means is connected to an external line feed and a fixed point located exterior to the housing means.

30. The communications assembly means of claim 26, wherein the communications assembly is connected to a vehicle.

31. A communications assembly comprising:
a housing having a length and a width and a base and a cover wherein the base and the cover have an exterior surface and an interior cavity when mated and wherein the base of the housing has a tapered first end and a widened second end and has a cross-sectional shape at a cross-section along a portion of the length at the second end;
a chassis positionable on an interior facing surface of the base; and
two or more antenna subassemblies positioned within the cavity of the housing in communication with the chassis wherein at least two antenna subassemblies are perpendicular to a chassis plane,
wherein the cross-sectional shape at the cross-section along the portion of the length of the second end is a shape that outlines a profile of the two or more antenna subassemblies positioned within the cavity of the housing at the second end of the housing.

32. The communications assembly of claim 31 wherein the assembly is configured to implement multi-antenna protocols.

33. The communications assembly of claim 31 wherein the multiple-antenna protocols are selected from the group comprising LTE, WI-FI, AM/FM, GPS and SDARS.

34. The communications assembly of claim 31, wherein the communications assembly is connected to an external line feed and a fixed point located exterior to the housing.

35. The communications assembly of claim 31, wherein the communications assembly is connected to a vehicle.
